(19) United States
(12) Patent Application Publication
(10) Pub. No.: US 2003/0019075 A1
(43) Pub. Date: Jan. 30, 2003

(54) Castor wheel construction

(76) Inventor: Ruggero Trevini, S. Angelo Lodigiano (IT)

Correspondence Address: James V. Costigan, Esq., Hedman & Costigan, P.C., Suite 2003, 1185 Avenue of the Americas, New York, NY, 10036-2646, US

(21) Appl. No.: 10/200,946

(22) Filed: Jul. 23, 2002

(30) Foreign Application Priority Data
Jul. 24, 2001 (IT) MI 2001 U 000421

(51) Int. Cl. B60B 33/00

(52) U.S. Cl. 16/35 R

(57) ABSTRACT

A castor wheel comprises a hub supporting a wheel body and a pedal lever, and engaging means, driven by the pedal lever, defining at least a locking position for locking the rotation of the wheel body and at least a free rotary position in which the wheel body can be freely rotated, characterized in that the engaging means comprise at least a tooth rigid with the pedal lever and designed for engaging a respective plurality of ridges which are circumferentially arranged on at least a surface of the wheel body.

### BACKGROUND OF THE INVENTION

The present invention relates to a castor wheel construction.

Castor wheels including a locking and unlocking device for respectively locking and unlocking the rotary movement of the wheel, which device conventionally comprise a pedal lever operating on the wheel by different types of interference or friction means are already known.

The braked castor wheels are used in a broad range of applications, and these castor wheels must be reliable in operation, and economically advantageous from a mere construction standpoint.

### SUMMARY OF THE INVENTION

Accordingly, the aim of the present invention is to provide such a castor wheel construction having very good operating and safety characteristics, while being very simple construction-wise.

Within the scope of the above mentioned aim, a main object of the invention is to provide such a castor wheel construction which comprises a very small number of component parts, which can be easily made and easily assembled.

Yet another object of the present invention is to provide such a castor wheel construction the use of which is easy and self-evident.

According to one aspect of the present invention, the above mentioned aim and objects, as well as yet other objects, which will become more apparent hereinafter, are achieved by a castor wheel construction comprising a supporting hub supporting a wheel body and a pedal lever, and engaging means, driven by said pedal lever, said engaging means defining at least a locking position for locking a rotation of a wheel body and at least a free position for allowing said wheel body to freely rotate, characterized in that said engaging means comprise at least a tooth rigid with said pedal lever and designed for engaging a plurality of ridges which are circumferentially arranged on at least a surface of said wheel body.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative, example in the accompanying drawings, where:

FIG. 1 is a front cross-sectional elevation view of the castor wheel construction according to the invention;

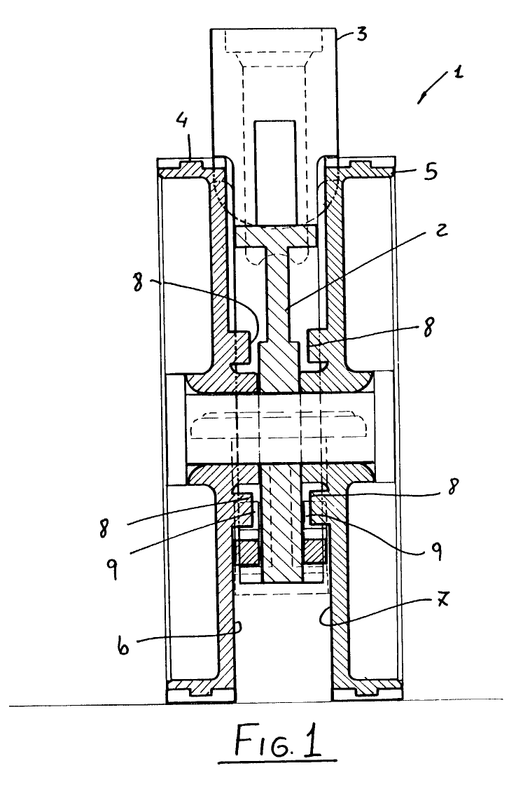

FIG. 2 is a further side elevation view, partially broken away, of the castor wheel construction according to the present invention, being shown in a locked position thereof; and

FIG. 3 is a view similar to FIG. 2, but showing the castor wheel construction according to the present invention, in a free rotary position or condition thereof.

### DESCRIPTION OF THE PREFERRED EMBODIMENT

With reference to the number references of the above mentioned figures, the castor wheel construction according to the present invention, which has been generally indicated by the reference number 1, comprises a hub 2, including an end-piece 3 for connection with an article, not specifically shown, which must be provided with castor wheels.

The hub 2 supports a wheel body, comprising two half-portions 4 and 5, which are made rigid with one another on said hub 2, in order to allow the wheel body to rotate with respect to the hub.

The two half-portions 4 and 5 of the wheel body have each an inner surface, respectively indicated at 6 and 7, facing the hub 2 and including bosses or ridges 8, arranged along a circumference about the rotary axis of the wheel body.

The ridges 8 are suitably beveled and have in the shown embodiment a drop shape, with a longitudinal axis radially extending with respect to the rotary axis of the wheel body.

The two pluralities of ridges 8, each for each half-portion 4 and 5 of the wheel body, are respectively designed for engaging a pair of teeth 9, with a tooth for each side, of a fork lever 10, pivoted at a pivot pin 11 on the hub 2.

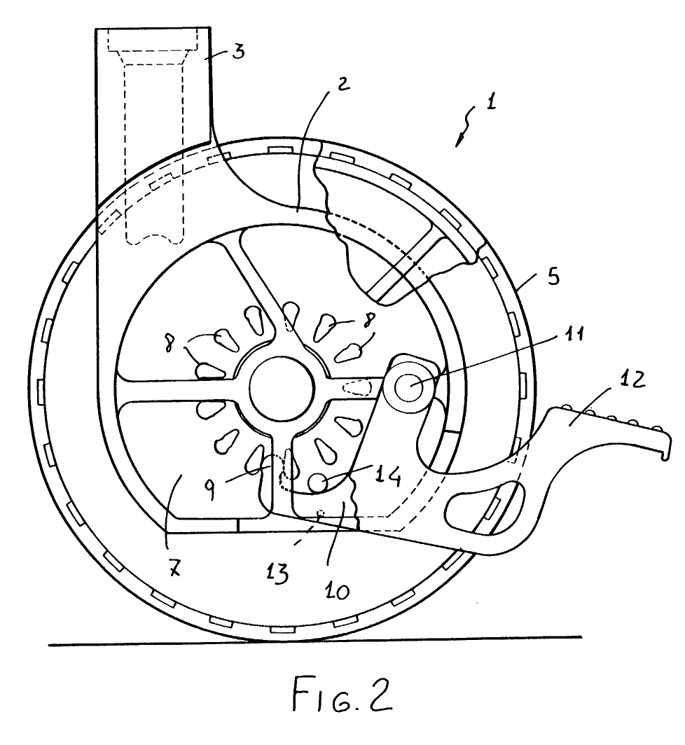

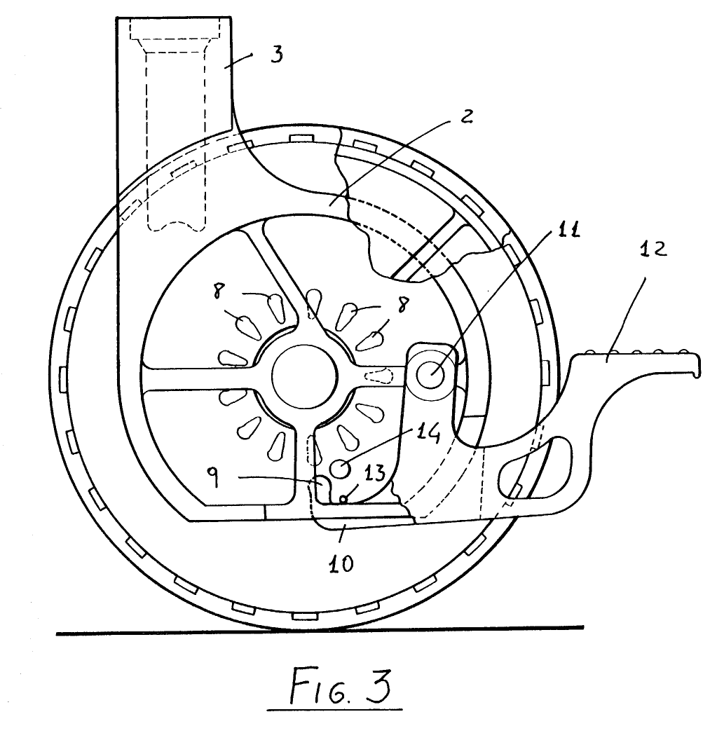

The fork lever 10 is moreover provided with a pedal 12, projecting outward of the wheel body to be driven by a foot, thereby displacing the fork lever 10 from a wheel body free rotary position, shown in FIG. 3, to a wheel body locked position, as shown in FIG. 2.

The drop-like beveled configuration of the ridges, and a rounded end of the tooth, allow to obtain a fluidic engagement between the tooth and ridges to prevent any jams for occurring as the tooth end is precisely arranged at a tooth, as the castor wheel must be locked.

In order to prevent the fork lever 10 from accidentally moving away from the locking position, the hub 2 comprises an interference element 13, including, for example, a boss or the like, designed for interfering with the lever 10, thereby requiring a given effort in order to disengage said lever from the interference element.

Moreover, an end of stroke or limit element 14, limiting the rotary movement of the lever 10 in the wheel locking position is provided.

All the disclosed elements, such as the ridges 8, interference element 10 and limit element 14 are made as a single body with the respective components they are rigid with, as said components are made.

It has been found that the invention fully achieves the intended aim and objects.

In fact, the invention provides a castor wheel construction which is very simple and unexpensive from a mere construction standpoint, while having very good operating features.

By a very small number of components, all of which can be easily made and assembled, a castor wheel construction with very good operating safety features has been provided.

In practicing the invention, the used materials and the contingent size and shapes, can be any, depending on requirements and the status of the art.

1. A castor wheel construction comprising a supporting hub supporting a wheel body and a pedal lever, and engaging means, driven by said pedal lever, said engaging means defining at least a locking position for locking a rotation of a wheel body and at least a free position for allowing said wheel body to freely rotate, characterized in that said engaging means comprise at least a tooth rigid with said pedal lever and designed for engaging a plurality of ridges which are circumferentially arranged on at least a surface of said wheel body.

2. A castor wheel construction, according to claim 1, characterized in that said wheel body comprises two half-portions made rigid with one another on said hub to allow said wheel body to rotate, with respect to said hub, and that the two half-portions of the wheel body have each an inner surface facing said hub and including ridges arranged along a circumference about the rotary axis of the wheel body.

3. A castor wheel construction, according to claim 2, characterized in that said ridges are beveled and have a drop shape, with a longitudinal axis radially arranged with respect to the rotary axis of the wheel body.

4. A castor wheel construction, according to claim 1, characterized in that said two pluralities of ridges, each for each half-portion of the wheel body, are respectively designed for engaging a pair of teeth, i.e. a tooth for each side of said lever, which has a fork-shape and is pivoted on a pin on said hub.

5. A castor wheel construction, according to claim 1, characterized in that said wheel construction further comprises an interference element designed for engaging said lever at said wheel body rotary locking position, thereby an effort would be required for disengaging said lever from said interference element and hence from said locked position of said wheel body.

6. A castor wheel construction, according to claim 1, characterized in that said castor wheel construction comprises a limit element designed for limiting the rotary movement of said lever in the castor wheel locking position.

7. A castor wheel construction, according to claim 1, characterized in that all the elements of said castor wheel construction such as said ridges, interference element and limit element are made as a single body, with their respective components to which they are coupled during the making process of said components.
